(19) United States
(12) Patent Application Publication
(10) Pub. No.: US 2026/0088309 A1
(43) Pub. Date: Mar. 26, 2026

(54) ELECTROCHEMICAL CELL

(71) Applicant: CERES INTELLECTUAL PROPERTY COMPANY LIMITED, --- (GB)

(72) Inventors: Per HJALMARSSON, Sussex (GB); Chandra MACAULEY, Sussex (GB)

(21) Appl. No.: 19/110,960

(22) PCT Filed: Sep. 12, 2023
(86) PCT No.: PCT/GB2023/052355

§ 371 Date: Mar. 12, 2025

(30) Foreign Application Priority Data
Sep. 13, 2022 (GB) 2213357.3

(51) Int. Cl. H01M 4/90; C25B 1/04; C25B 11/031; H01M 4/88; H01M 8/12; H01M 8/1226; H01M 8/1253; H01M 8/2432

(52) U.S. Cl. CPC H01M 4/9033; C25B 1/04; C25B 11/031; H01M 4/8835; H01M 4/8885; H01M 4/9066; H01M 8/1226; H01M 8/1253; H01M 8/2432; H01M 2008/1293

(57) ABSTRACT

An electrochemical cell is disclosed having a porous metal support, at least one layer of a first electrode on the porous metal support, a first electron-blocking electrolyte layer of rare earth doped zirconia on the at least one layer of the first electrode, and a second bulk electrolyte layer of rare earth doped ceria on the first electron-blocking electrolyte layer. The first electron-blocking electrolyte layer of rare earth doped zirconia may have a thickness of 0.5 μm or greater, and the second bulk electrolyte layer of rare earth doped ceria may have a thickness of 4 μm or greater.

### FIELD OF THE INVENTION

The present invention relates to electrochemical cells, to stacks of electrochemical cells, and to methods of producing such electrochemical cells. The present invention also relates to electrolysis systems comprising such electrochemical cells and to methods of operating such electrochemical cells in electrolysis mode.

### BACKGROUND OF THE INVENTION

Electrochemical cells formed of oxide layers (often known as solid oxide cells: SOC) may be used as fuel cells or electrolyser/electrolysis cells.

SOC fuel cell units produce electricity using an electrochemical conversion process that oxidises fuel. SOC cell units can also, or instead, operate as regenerative fuel cell (or reverse fuel cell) units, often known as solid oxide electrolyser fuel cell units, for example to separate hydrogen and oxygen from water, or carbon monoxide and oxygen from carbon dioxide.

SOC units are generally ceramic-based, using an oxygen-ion conducting metal-oxide-containing ceramic as an electrolyte. Many ceramic oxygen ion conductors (for instance, doped zirconium oxide or doped cerium oxide) have useful ion conductivities at temperatures in excess of 500° C. (for cerium-oxide based electrolytes) or 650° C. (for zirconium oxide-based ceramics), so SOCs tend to operate at elevated temperatures.

A solid oxide fuel cell (SOFC) generates electrical energy through the electrochemical oxidation of a fuel gas (usually hydrogen-based). In operation, the electrolyte of the SOFC conducts oxygen ions from a cathode to an anode located on opposite sides of the electrolyte. A fuel, for example a fuel derived from the reforming of a hydrocarbon or alcohol, contacts the anode (usually known as the “fuel electrode”) and an oxidant, such as air or an oxygen rich fluid, contacts the cathode (usually known as the “air electrode”).

A solid oxide electrolyser cell (SOEC) may have the same structure as an SOFC but is in practice an SOFC operating in reverse, or in a regenerative mode, to achieve the electrolysis of water and/or carbon dioxide.

Conventional ceramic-supported (e.g. anode-supported) SOCs have low mechanical strength and are vulnerable to fracture. Hence, metal-supported SOCs have recently been developed which have the active fuel cell component layers supported on a metal substrate. In these cells, the ceramic layers can be very thin since they only perform an electrochemical function: that is to say, the ceramic layers are not self-supporting but rather are thin coatings/films laid down on and supported by the metal substrate. Such metal supported SOC stacks are more robust, lower cost, have better thermal properties than ceramic-supported SOCs and can be sealed using conventional metal welding techniques.

Applicant's earlier patent application WO-A-2015/136295 discloses metal-supported SOFCs in which the electrochemically active layer (or active fuel cell component layer) comprises anode, electrolyte and cathode layers respectively deposited (e.g. as thin coatings/films) on, and supported by, a metal support plate (e.g. foil). The metal support plate has a porous region surrounded by a non-porous region with the active layers being deposited upon the porous region so that gases may pass through the pores from one side of the metal support plate to the opposite side to access the active layers coated thereon. The porous region comprises discrete apertures (holes drilled through the metal foil substrate) extending through the support plate, overlying the anode (or cathode, depending on the orientation of the electrochemically active layers). Applicant's earlier patent application GB-A-2456445 discloses depositing a layer of metal oxide crystalline ceramic on a substrate.

US-A-2019/0330751 discloses SOEC systems with heating ability. WO-A-2021/201195 discloses metal-supported SOFC configured by providing an anode electrode layer, an electrolyte layer, and a cathode electrode layer on the surface of a metal support. US-A-2007/269701 discloses an SOFC with a metal support. EP-A-1306920 discloses a unit cell for a fuel cell and solid oxide fuel cell. CN-A-113764710 and CN-A-113782799 disclose metal supported SOECs. US-A-2011/076594 discloses a ceria-based bulk electrolyte layer in SOFCs. JP-A-2011 181262 and KR-A-20120137917 disclose SOFCs which are composed of electrodes and electrolyte with no metal support. US-A-2020/0014051 discloses a manufacturing method for a metal-supported electrochemical element.

There have been attempts to lower manufacturing cost, to increase reliability and increase the efficiency of SOFCs and SOECs. Unfortunately, materials with higher performance at lower temperatures may be less stable than materials that are currently used. In particular, some electrolyte materials may be partially reduced when exposed to a fuel atmosphere, exhibiting mixed ionic/electronic conductivity, reducing operating efficiency.

There is a need, therefore, to provide electrochemical cells with improved electrolyte systems. It is an aim of the present invention to address such a need.

### SUMMARY OF THE INVENTION

The present invention accordingly provides, in a first aspect, an electrochemical cell comprising: a porous metal support, at least one layer of a first electrode on the porous metal support, a first electron-blocking electrolyte layer of rare earth doped zirconia on the at least one layer of the first electrode, and a second bulk electrolyte layer of rare earth doped ceria on the first electrolyte layer.

The first electron-blocking electrolyte layer of rare earth doped zirconia may have a thickness of 0.5 μm or greater.

The second bulk electrolyte layer of rare earth doped ceria may have a thickness of 4 μm or greater.

This is advantageous because it may result in less reduction of the second bulk electrolyte layer of doped ceria during use. Reduction of doped ceria may result in the second bulk electrolyte layer developing higher electronic conductivity and may lead to expansion of the doped ceria layer. Mixed electronic/ionic conductivity of the electrolyte can lead to reduced efficiency. Expansion of the doped ceria layer may reduce the longevity of the electrochemical cell.

The first electron-blocking electrolyte layer of rare earth doped zirconia may have a thickness of 1 μm or greater, optionally 2 μm or greater.

The first electron-blocking electrolyte layer of rare earth doped zirconia may have a thickness of 5 μm or lower. Optionally, the first electron-blocking electrolyte layer of rare earth doped zirconia may have a thickness of 4 μm or lower, or 3 μm or lower.

Thus, the first electron-blocking electrolyte layer of rare earth doped zirconia may have a thickness in the range 0.5 μm to 5 μm, a thickness in the range 1 μm to 4 μm, or a thickness in the range 2 μm to 3 μm

Generally, thicknesses of the first electron-blocking electrolyte layer in these ranges are advantageous because they provide that the first and second electrolyte layers together have low electronic conductivity or are electronically insulating. The optimum thickness is a trade-off between electronic leakage (which may start to occur when the layer is thinner) and ionic resistance (which tends to increase when the layer is thicker).

The first electron-blocking electrolyte layer of rare earth doped zirconia may advantageously act to block electronic leak currents by virtue of being a pure oxide ion conductor.

Additionally, the first electron-blocking electrolyte layer may provide sufficiently low gas permeability such that the second bulk electrolyte layer of doped ceria is not significantly reduced (which would make it electronically conductive) in use.

The first electron blocking electrolyte layer is preferably dense enough to reduce diffusion of reducing fuel gas (e.g. hydrogen) to the second bulk electrolyte layer. Thus, preferably the first electron-blocking electrolyte layer has low porosity or is not substantially porous (although it may have some closed porosity). Providing a dense layer (and reducing porosity) may be achieved by careful selection of particle size, sintering aids and temperature profile.

The second bulk electrolyte layer of rare earth doped ceria may have a thickness of 17 μm or lower. Optionally, the second bulk electrolyte layer of rare earth doped ceria may have a thickness of 15 μm or lower, optionally 12 μm or lower.

The second bulk electrolyte layer of rare earth doped ceria may have a thickness of 4 μm or greater. Optionally, the second bulk electrolyte layer of rare earth doped ceria may have a thickness of 5 μm or greater, 6 μm or greater or 7 μm or greater.

Thus, the second bulk electrolyte layer of rare earth doped ceria may have a thickness in the range 4 μm to 17 μm, a thickness in the range 5 μm to 15 μm, or a thickness in the range 6 μm to 12 μm

The second bulk electrolyte layer of rare earth doped ceria has a primary purpose of facilitating oxygen ion diffusion from one electrode to another and may advantageously provide a mechanically stable layer having very low or no gas permeability and having ionic resistance that is as low as possible.

A second bulk electrolyte layer may be advantageous because it provides a more gas tight and mechanically robust layer. However, optimum thickness is a trade-off between gas leakage (more likely when the layer is thinner) and ionic resistance (which tends to increase with thickness).

Optionally, the second bulk electrolyte layer of rare earth doped ceria may be thicker than the first electrolyte layer of rare earth doped zirconia.

The electrochemical cell may comprise a solid oxide electrochemical cell.

The electrochemical cell may be a fuel cell, or an electrolysis (also referred to as an electrolyser) cell. In fuel cell mode, a fuel contacts the anode (fuel electrode) and an oxidant, such as air or an oxygen-rich fluid, contacts the cathode (air electrode), so in fuel cell mode operation, the air electrode will be the cathode. A solid oxide electrolyser cell (SOEC) may have the same structure as an SOFC, but is essentially the SOFC operating in reverse, or in a regenerative mode, to achieve the electrolysis of reagents (e.g. water and/or carbon dioxide to produce hydrogen gas and/or carbon monoxide and oxygen).

The advantages of the disclosure are particularly beneficial when the electrochemical cell has an applied voltage. Thus, the electrochemical cell may be, in use, an electrolysis cell.

Alternatively, the electrochemical cell may be, in use, a fuel cell or a reversible fuel cell.

Further alternatives are that the electrochemical cell may be, in use, an oxygen separator, or a sensor.

The rare earth doped zirconia may comprise zirconia doped with at least one rare earth element selected from Y, Sc or a lanthanide (Ln). An example of Ln may be Yb.

The rare earth doped zirconia may be selected from scandia stabilized zirconia (ScSZ), yttria stabilized zirconia (YSZ), scandia ceria co-stabilized zirconia (ScCeSZ), ytterbia stabilized zirconia (YbSZ), scandia yttria co-stabilized zirconia (ScYSZ) and mixtures thereof. Doped zirconia may be a solid solution which may be of formula Zr₍₁₋ₓ₎MₓO_{(2-0.5x-δ)} where 0<x≤0.2, and M is a rare earth element (M=Sc, Y, Ln or a mixture).

The dopant concentration in the zirconia may be in the range 5 to 15 atom %, optionally in the range 6 to 12 atom %.

Where the dopant is Y, the Y dopant concentration in the zirconia may be in the range 5 to 15 atom %, optionally about 8 atom %. Where the dopant is Sc, the Sc dopant concentration in the zirconia may be in the range 5 to 15 atom %, optionally about 10 atom %.

The rare earth doped ceria may comprise ceria doped with at least one rare earth element selected from Y, Sc or a lanthanide (Ln).

The rare earth doped ceria may be selected from samarium-doped ceria (SDC), gadolinium-doped ceria (GDC), samaria-gadolinia doped ceria (SGDC) and mixtures thereof. Gd and Sm are advantageous and may yield higher ionic conductivities. Doped ceria may be a solid solution having the formula, Ce₍₁₋ₓ₎MₓO_{(2-0.5x-δ)} where 0<x≤0.5, (M=Sc, Y, Ln or a mixture).

The dopant concentration in the ceria may be in the range 3 to 45 atom %, optionally 5 to 40 atom %, optionally 10 to 20 atom %

The layer of the first electrode may comprise doped ceria or doped zirconia. Suitably, the layer of the first electrode may comprise ceria gadolinium oxide (CGO).

The layer of the first electrode may comprise a source of nickel, optionally nickel oxide. The layer of the first electrode may comprise nickel CGO cermet.

The layer of the first electrode may have a thickness of 3 μm or higher, optionally 5 μm or higher, optionally 10 μm or higher, optionally 15 μm or higher. The layer of the first electrode may have a thickness of 60 μm or lower, 50 μm or lower, optionally 45 μm or lower, optionally 40 μm or lower, optionally 35 μm or lower. Thus, the layer of the first electrode may have a thickness in the range 3 μm to 60 μm, 5 μm to 50 μm, optionally 15 μm to 25 μm.

The first electrode may have one or more layers. Thus, the layer of the first electrode may be the only layer of the first electrode or may be the first layer of the first electrode.

The first electrode may be a fuel electrode. This is particularly advantageous because it reduces the possibility of an increase in the electronic conductivity of doped ceria that may occur in a reducing atmosphere. This also reduces the chance that the second bulk electrolyte layer may crack due to expansion that may occur on reduction.

Arranging the first electron blocking electrolyte layer on the fuel side of the cell at least partially blocks the doped ceria layer from the more reducing (low oxygen chemical) potential that may otherwise affect it. This is beneficial because doped ceria becomes less electronically conducting in more oxidizing atmospheres. Furthermore, in more reducing atmosphere (at usual operating temperatures for SOC) doped ceria may chemically reduce and expand especially if there is an applied voltage (as in SOEC mode). The consequence may be cell failure under compressive stress at a certain critical voltage (a function of temperature). In addition there may be a creep mechanism that affects the layer after a period of time at the operating temperature, during temperature cycling and under applied voltage.

The electrochemical cell may further comprise a second electrode on the electrolyte layer. The second electrode may be an air electrode. The second electrode may comprise one or more layers. For example the second electrode may comprise an active second electrode layer (located closer to the electrolyte) and a bulk second electrode layer. The active second electrode layer and bulk second electrode layer may comprise a suitable material, the bulk layer material selected for example from lanthanum cobaltite, lanthanum ferrite, lanthanum nickel ferrite, La_{0.99}Co_{0.4}Ni_{0.6}O_{(3-δ)} (LCN60) and mixtures thereof.

The metal support may comprise a metallic foil (i.e. solid metal) in which openings are provided. That has an advantage that the porosity can be tailored and positioned in specific areas of the substrate. Alternatively or in addition, a metal substrate may have inherent porosity (e.g. isotropic porosity) formed for example as tape cast by powder depositing a film that is then sintered to form a porous substrate. References herein to metal supports or a porous steel sheet may refer to either of these.

The porous metal support may comprise steel, preferably stainless steel. Usually, the porous metal support may comprise a drilled metal support, optionally a laser drilled metal support.

In some circumstances (e.g. where it is desired to further protect the metal support from corrosion) the porous metal support may comprise a barrier layer on the surface thereof and the electrode layer may be on the barrier layer.

The electrochemical cell may comprise other layers.

Optionally, the electrochemical cell does not comprise a second layer of rare earth doped zirconia.

Electrochemical cells according to the first aspect may be arranged in a stack of electrochemical cell units, electrically connected in series.

Thus, there is provided in a second aspect, a stack of electrochemical cells, wherein each electrochemical cell is as set out above.

The layer of the first electrode, first electrolyte layer and second electrolyte layer may be deposited sequentially on the metal support by any suitable method.

In a third aspect, there is provided a method of producing an electrochemical cell, the method comprising, providing a porous metallic substrate having on a surface thereof at least one layer of a first electrode, providing a first ink comprising a precursor for a first electron-blocking electrolyte layer of rare earth doped zirconia, applying the first ink on to the at least one layer of the first electrode, to form the first electron-blocking electrolyte layer of rare earth doped zirconia, optionally drying, optionally sintering; providing a second ink comprising a precursor for a second bulk electrolyte layer of rare earth doped ceria, applying the second ink on to the first electron-blocking electrolyte layer, to form the second bulk electrolyte layer of rare earth doped ceria, optionally drying, and optionally sintering.

The first and/or the second ink may be applied by spraying (for example atomized spraying), or by printing, optionally roller printing, jet printing or screen-printing.

Alternatively the electron blocking layer may be applied and/or deposited using physical vapor deposition (PVD).

Optional sintering may be performed at a temperature in the range 750° C. to 1100° C., preferably from 800° C. to 970° C. Sintering may be performed in an air atmosphere.

In a fourth aspect, there is accordingly provided an electrochemical cell obtainable by a method as claimed in the third aspect.

In a fifth aspect, there is accordingly provided an electrolysis system comprising an electrochemical cell according to the first aspect.

In a sixth aspect, there is accordingly provided a method of operating an electrochemical cell in electrolysis mode, the method comprising providing an electrochemical cell according to the first aspect, contacting the electrochemical cell with a reagent, and applying a potential to the electrochemical cell.

The reagent may be, for example, water and/or carbon dioxide to produce hydrogen gas and/or carbon monoxide and oxygen respectively.

### Definitions

In this specification, the terms “rare earth metal” or “rare earth element” refer to metals selected from Y, Sc, and lanthanoid.

“Lanthanoid”, “lanthanide” and “Ln” are used interchangeably and mean the metallic chemical elements with atomic numbers 57-71.

The term “dopant” as used herein is not intended to be restricted to a maximum percentage of elements, ions or compounds added to chemical structures. Similarly, the term “doping” is intended to mean the addition of a certain amount of elements, ions or compounds to a material. It is not limited to a maximum quantity of material, after which, further addition of material no longer constitutes doping.

The term “perovskite structure” as used herein refers to a single network of chemically bonded crystal structures which have a generally perovskite (ABX₃) structure. This does not mean that this single network need possess a single, uniform crystal structure throughout the entire structure. However, where different crystal structures occur between different regions of the network, it is often the case that these regions have complementary structures permitting chemical bonds to more easily form therebetween.

The term “solid oxide cell” (SOC) is intended to encompass both solid oxide fuel cells (SOFCs) and solid oxide electrolysis cells (SOECs).

The term “source of” an element, compound or other material refers to a material comprising the element, compound or other material whether or not chemically bonded in the source. The source of the element, compound or other material may be an elemental source (e.g. Ln, Ni or O₂) or may be in the form of a compound or mixture comprising the element, compound or other material including one or more of those elements, compounds or materials.

In this specification references to electrochemical cell, SOC, SOFC and SOEC may refer to tubular or planar cells. Electrochemical cell units may be tubular or planar in configuration. Planar fuel cell units may be arranged overlying one another in a stack arrangement, for example 100-200 fuel cell units in a stack, with the individual fuel cell units arranged electrically in series. References to “a stack of electrochemical cells” therefore refer to a plurality of electrochemical cells units arranged electrically in series.

Electrochemical cells may be fuel cells, reversible fuel cells or electrolyser cells. Generally, these cells may have the same structure and reference to electrochemical cells may refer (unless the context suggests otherwise) to any of these types of cell.

“Oxidant electrode” or “air electrode” and “fuel electrode” are used herein and may be used interchangeably to refer to cathodes and anodes respectively of SOFCs because of potential confusion between fuel cells or electrolyser/electrolysis cells.

Electrochemical cells as encompassed by the invention may comprise:
a) two planar components welded together with fluid volume in between (e.g. substrate with electrochemical layers and interconnecter (separate plate))
b) three planar components welded together with fluid volume in between (e.g. substrate with electrochemical layers and interconnecter (separate plate) and spacer providing fluid volume).

The various features of aspects of the disclosure as described herein may be used in combination with any other feature in the same or other aspect of the disclosure, if needed with appropriate modification, as would be understood by the person skilled in the art.

Furthermore, although all aspects of the invention or disclosure preferably “comprise” the features described in relation to that aspect, it is specifically envisaged that they may “consist” or “consist essentially” of those features outlined in the claims.

The invention will now be described with reference to accompanying figures and examples.

### BRIEF DESCRIPTION OF THE FIGURE

FIG. 1 shows a cross section of an electrochemical cell unit.

FIG. 2 depicts a scanning electron micrograph (SEM) of a section through a part of an electrochemical cell unit.

FIG. 3 shows a graph of cell voltage as a function of normalized current density of a cell at 550° C.; 50%:50% H₂:H₂O according to the disclosure.

### DETAILED DESCRIPTION OF THE INVENTION

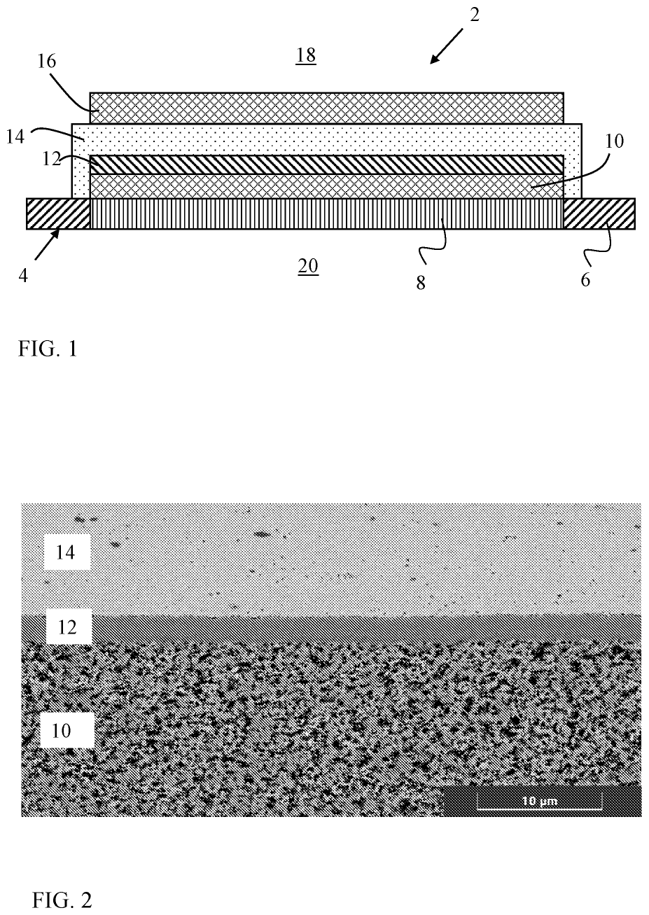

FIG. 1 shows, schematically and not to scale (for reasons of clarity) a cross section of an electrochemical cell unit 2 that may be a SOFC or SOEC. A ferritic stainless steel metal support 4 has a peripheral, non-porous portion 6 and a central, porous portion 8 where holes have been drilled through the metal support 4. A barrier layer (not shown) to reduce corrosion is located on the surface of the metal support 4. A layer of a fuel electrode 10 of Ni:CGO of thickness 15 μm to 35 μm is located on the porous portion 8 of the metal support 4. A first electrolyte layer 12 of rare earth (RE) stabilized zirconia (RE=Y, Sc or any Ln, e.g. Yb) of thickness 0.5 μm or greater (e.g. 1 μm to 4 μm) is located on the fuel electrode layer 10. A second electrolyte layer 14 of rare earth doped ceria (RE=Y, Sc or any Ln) of thickness 4 μm or greater (optionally 6 μm to 12 μm) is located on the first electrolyte layer 12. The second 14 electrolyte layer surrounds the fuel electrode layer 10 to prevent gas flowing through the fuel electrode layer 10 from the fuel side 20 to the air (oxidant) side 18 or vice versa. The cell unit is completed with a second (air) electrode assembly 16 located on the second electrolyte layer 14. The second electrode 16 may be formed of an active air electrode layer and a bulk air electrode layer of LCN60.

FIG. 2 shows a SEM of a part of a cell showing the fuel electrode layer 10, the first electrolyte layer 12 of rare earth (RE) stabilized zirconia (8YZ, i.e. 8 atom % Y doped zirconia) and the second electrolyte layer 14 of rare earth doped ceria (RE=Y, Sc or any Ln).

At operating temperatures (e.g. 550° to 625° C.) of the electrochemical cells according to this disclosure, ceria may chemically reduce and expand when voltage increases (this occurs especially in SOEC mode). This is not true for YSZ. The consequence is a cell failure under compressive stress at a certain critical voltage (depending on temperature). With temperature cycling and applying voltage at operating temperature, creep effects may also occur under stress reducing the longevity of the cell.

To address this issue, embodiments of electrochemical cells of this disclosure may be constructed with a bilayer electrolyte comprising a first layer of rare earth (RE) stabilized zirconia (RE=Y, Sc or any Ln, e.g. Yb), the dopant concentration being in the range of 6-12% (e.g. where % is atom % of metal), where the optimum concentration depends on the RE (˜8% for Y, ˜10% for Sc for example). The function of the layer is to block electronic leak currents by virtue of being a pure oxide ion conductor and provide low or no gas permeability such that the second layer of doped ceria is not significantly reduced (which would make it electronically conductive). The thickness may be in the range 1-4 μm thick or 2-3 μm. Such YSZ or ScSZ thickness is believed to provide enough electronic blocking functionality: the thickness is a trade-off between electronic leakage (may occur in thinner layers) and ionic resistance (tends to increase with thickness). The layer is dense enough to prevent H₂ gas from passing through to reach the CGO electrolyte layer. Density may be achieved by careful selection of particle size, sintering aids and temperature profile.

The second layer of rare earth doped ceria (RE=Y, Sc or any Ln) may have a dopant concentration in the range of 5-40% where the optimum concentration is 10-20%. The primary function is to provide a mechanically stable and having very low or no gas permeability. The key performance metric is its ionic resistance which should be lowest possible. The thickness may be in the range of 5-15 μm or 6-10 μm. The thicker CGO layer provides a gas tight and mechanically robust electrolyte.

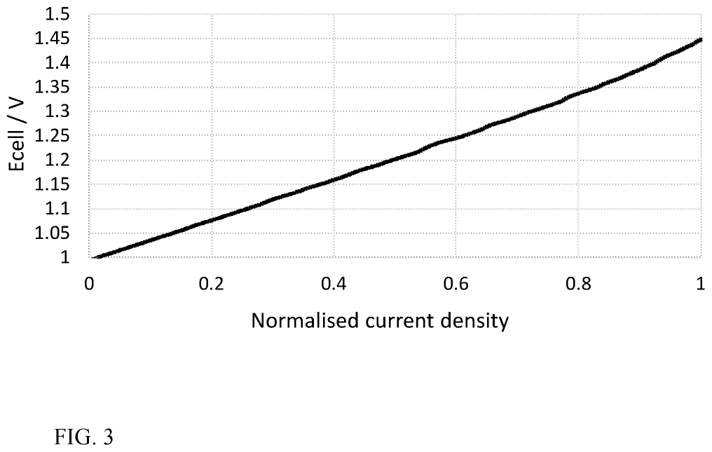

FIG. 3 shows an I-V curve of a cell at 550° C. with 50%:50% H₂:H₂O atmosphere according to the disclosure showing that the cell voltage may be up to 1.45 V at a normalized current density of 1.

Electrochemical cells according to the disclosure substantially reduce the electronic conductivity of CGO by reducing or eliminating the thermodynamic conditions that lead to reduction of ceria (i.e. a reducing atmosphere). For the same reason it will also reduce electrolyte cracking due to chemical expansion on reduction of ceria.

### REFERENCE NUMERALS

2 electrochemical cell
4 metal support
6 non-porous portion of metal support
8 porous portion of metal support
10 fuel electrode layer
12 first electrolyte layer
14 second electrolyte layer
16 second (air) electrode assembly
18 oxidant (air) side
20 fuel side

All publications mentioned in the above specification are herein incorporated by reference. Although illustrative embodiments of the invention have been disclosed in detail herein, with reference to the accompanying drawings, it is understood that the invention is not limited to the precise embodiment and that various changes and modifications can be performed therein by one skilled in the art without departing from the scope of the invention as defined by the appended claims and their equivalents.

1. An electrochemical cell comprising:
a porous metal support,
at least one layer of a first electrode on the porous metal support,
a first electron-blocking electrolyte layer of rare earth doped zirconia on the at least one layer of the first electrode, and
a second bulk electrolyte layer of rare earth doped ceria on the first electron-blocking electrolyte layer.

2. An electrochemical cell as claimed in claim 1, wherein the first electron-blocking electrolyte layer of rare earth doped zirconia has a thickness of 0.5 μm or greater.

3. An electrochemical cell as claimed in claim 1, wherein the second bulk electrolyte layer of rare earth doped ceria has a thickness of 4 μm or greater.

4. An electrochemical cell as claimed in claim 1, wherein the first electron-blocking electrolyte layer of rare earth doped zirconia has a thickness of 5 μm or lower.

5. An electrochemical cell as claimed in claim 1, wherein the second bulk electrolyte layer of rare earth doped ceria has a thickness of 17 μm or lower.

6. An electrochemical cell as claimed claim 1, wherein the electrochemical cell is a solid oxide cell.

7. An electrochemical cell as claimed in claim 1, wherein the rare earth doped zirconia comprises zirconia doped with at least one rare earth element selected from Y, Sc or a lanthanide (Ln).

8. An electrochemical cell as claimed in claim 1, wherein the rare earth doped ceria comprises ceria doped with at least one rare earth element selected from Y, Sc or a lanthanide (Ln).

9. (canceled)

10. An electrochemical cell as claimed in claim 1, wherein the layer of the first electrode comprises doped ceria, optionally wherein the layer of the first electrode comprises doped ceria gadolinium oxide (CGO).

11. (canceled)

12. An electrochemical cell as claimed in claim 1, wherein the layer of the first electrode comprises nickel CGO cermet.

13. An electrochemical cell as claimed in claim 1, wherein the layer of the first electrode has a thickness of 3 μm or higher, optionally 5 μm or higher, optionally 10 μm or higher, optionally 15 μm or higher.

14. An electrochemical cell as claimed in claim 1, wherein the layer of the first electrode has a thickness of 50 μm or lower, optionally 45 μm or lower, optionally 40 μm or lower, optionally 35 μm or lower.

15. (canceled)

16. An electrochemical cell as claimed in claim 1, further comprising a second electrode on the second electrolyte layer, optionally wherein the second electrode is an air electrode.

17. An electrochemical cell as claimed in claim 1, wherein the porous metallic substrate comprises a steel substrate, preferably a stainless steel substrate.

18. (canceled)

19. An electrochemical cell as claimed in claim 1, wherein the porous metallic substrate comprises a barrier layer on the surface thereof and the layer of the first electrode is on the barrier layer.

20. A stack of electrochemical cells, wherein each electrochemical cell is as claimed in claim 1.

21. A method of producing an electrochemical cell, the method comprising
providing a porous metallic substrate having on a surface thereof at least one layer of a first electrode,
providing a first ink comprising a precursor for a first electron-blocking electrolyte layer of rare earth doped zirconia,
applying the first ink on to the at least one layer of the first electrode, to form the first electron-blocking electrolyte layer of rare earth doped zirconia,
optionally drying,
optionally sintering;
providing a second ink comprising a precursor for a second bulk electrolyte layer of rare earth doped ceria,
applying the second ink on to the first electron-blocking electrolyte layer, to form the second electrolyte layer of rare earth doped ceria,
optionally drying, and
optionally sintering.

22. A method as claimed in claim 21, wherein the first and/or the second ink is applied by printing, optionally screen-printing.

23. An electrochemical cell obtainable by a method as claimed in either claim 21.

24. (canceled)

25. A method of operating an electrochemical cell in electrolysis mode, the method comprising providing an electrochemical cell as claimed in claim 1, contacting the electrochemical cell with a reagent to be subject to electrolysis, and applying a potential to the electrochemical cell.
